(19) United States
(12) Patent Application Publication
(10) Pub. No.: US 2002/0049652 A1
(43) Pub. Date: Apr. 25, 2002

(54) Home inventory system

(76) Inventors: James H. Moore, Sammamish, WA (US); Masahito Watanabe, Duvall, WA (US)

Correspondence Address: NIXON & VANDERHYE P.C., 8th Floor, 1100 North Glebe Road, Arlington, VA, 22201, US

(21) Appl. No.: 09/927,453

(22) Filed: Aug. 13, 2001

Related U.S. Application Data
(60) Provisional application No. 60/242,748, filed on Oct. 25, 2000.

(51) Int. Cl. G06F 17/60

(52) U.S. Cl. 705/29

(57) ABSTRACT

A method of tracking products in inventory comprises receiving an identifier in a first computer system, the identifier identifying a transaction in which at least one product has been purchased, and transmitting a contact signal from the first computer system to a second computer system, the second computer system storing information relating to a plurality of available products. Information relating to the purchased product is transmitted from the second computer system to the first computer system in response to the second computer receiving the contact signal and used to update information relating to the products in inventory. The identifier is received in the first computer system by scanning a bar code representing the identifier, the bar code being printed on a receipt relating to the transaction. The contact signal and the information relating to the purchased product are transmitted via an internet connection established between the first and second computer systems.

### CROSS REFERENCE TO RELATED APPLICATION

This application claims the benefit of U.S. Provisional Application No. 60/242,748 filed Oct. 25, 2000, the contents of which are incorporated herein by reference.

### BACKGROUND OF THE INVENTION

1. Field of the Invention

The present invention relates to a computerized inventory system. More particularly, the present invention relates to a Home Inventory System (HIS) that includes a versatile database which records incoming home inventory data by reading a unique identifier from a store receipt and receiving product information data downloaded from a store database via the internet. The incoming home inventory data is used to update existing home inventory data and to provide information (e.g., warnings, reminders, etc.) to the user and/or answer queries from the user.

2. Description of Related Art

It is often necessary for a resident to determine what inventory items are present and how much of each in-inventory item is present. For example, it is often necessary to determine what consumable products used at home (e.g., toilet paper, toothpaste, paper towels, laundry detergent, soap, shampoo, butter, milk, beer, etc.) are running out or are totally depleted. Even when it is known what items are available in the home's inventory, all of the applications that these items can be used for may remain unknown. For example, even if all of the ingredients needed to prepare a meal are in-inventory, the possible meal is not necessarily known. Also, even if an item(s) is in-inventory, it may not be known whether this item(s) has expired as being unused within a given period of time (e.g., an uneaten, spoiled food product). It may also be unknown what item(s) is needed to replenish the inventory. For example, it may not be known what item(s) needs to be purchased from a supermarket to replenish the home inventory.

### BRIEF SUMMARY OF THE INVENTION

The present invention can assist in resolving all of the above problems. Specifically, a system according to the present invention includes, inter alia, (i) a store computer and database, and (ii) a home computer that is operatively coupled to a reader (e.g., a bar code reader). The reader is capable of scanning a unique identifier from a store receipt and the home computer is capable of contacting the store computer via the internet. The store computer downloads to the home computer the product information for all of the products purchased during the transaction indicated by the identifier. This information is downloaded via the internet, processed by the home computer, and stored in a home database. This information is used by the home computer to update the existing inventory information. The updated information is stored in the home database.

The home computer and database use the product information and other data input to the home computer reflecting preset condition(s), past usage model(s) and/or entered data reflecting the actual usage, expiration and/or disposal of inventory items to provide warnings and reminders to the user or to answer user inquiries. For example, the home computer can output a warning that certain inventory item(s) is running low, output a warning when inventory item(s) is close to expiration, or suggest possible ways (e.g., meals) of using inventory item(s). The home computer can also provide a possible goal based upon available inventory item(s) such as a possible dinner menu based upon available ingredients. The home computer can also provide a list of needed item(s) (e.g., a shopping list) based on desired applications and/or item(s) that have run out, run low and/or expired.

While the description of the present invention will hereinafter refer to a “Home Inventory System (HIS)”, those skilled in the art will understand that the invention could be used in any setting (e.g., a business or commercial setting) relating to inventory management in accordance with the present invention.

### BRIEF DESCRIPTION OF THE DRAWINGS

The invention will be further understood by review of the following detailed description of the invention when read in conjunction with the drawings, in which:

FIG. 1 is a block diagram illustrating an exemplary embodiment of a Home Inventory System (HIS) in accordance with the present invention; and

FIG. 2 is a diagram illustrating the operation of the Home Inventory System (HIS) in accordance with the present invention.

### DETAILED DESCRIPTION OF THE INVENTION

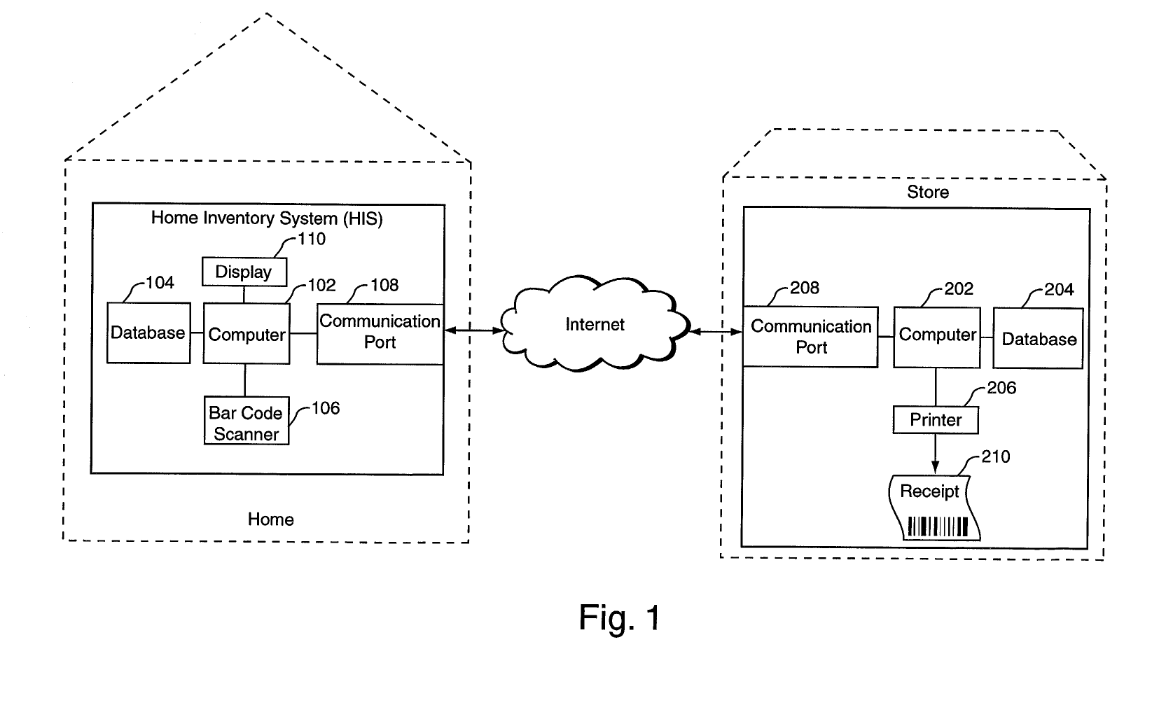

FIG. 1 illustrates an exemplary embodiment of a Home Inventory System (HIS) in accordance with the present invention. The HIS includes a home computer 102, a home database 104, a bar code scanner 106, communication port 108 and a display 110. The home computer 102 can be, for example, a pc-based or stand-alone device or a home network connecting multiple pc's and stand alone devices. The home computer 102 is operatively connected to each of the home database 104, bar code scanner 106, communication port 108 and display 110. The home computer 102 of the HIS communicates with a store computer 202 through the communication port 108 and a wide area network connection such as an internet connection. The store computer 202 is operatively connected to a store database 204, communication port 208 and a printer 206 for generating receipts 210 (one shown). The receipt 210 has a bar code which forms a unique identifier for an associated transaction. While the computer 202 and database 204 are described as a “store” computer 202 and “store” database 204, respectively, it will be understood that this does not necessarily mean that the computer 202 and database 204 are physically located within the store, but rather the computer 202 and database 202 process and hold data relating to the store. It will also be understood that while only one store is shown in FIG. 1, multiple stores each having their own computer and database are capable of communicating data to the HIS via the network connection.

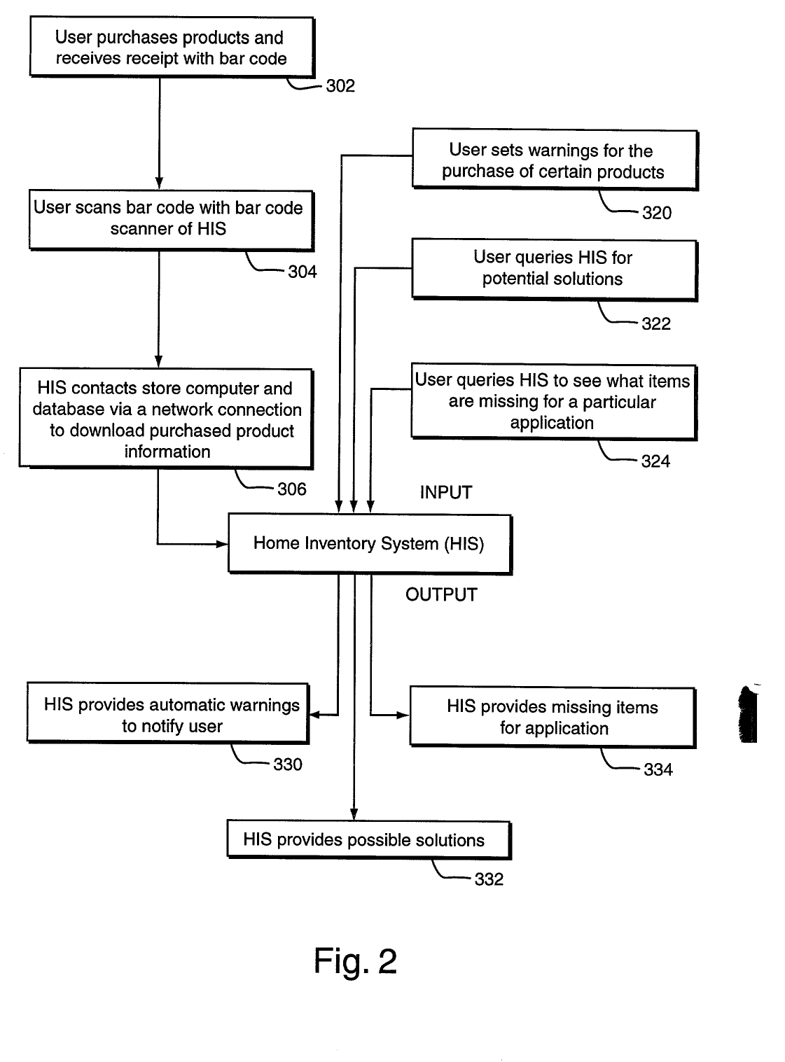

FIG. 2 illustrates the operation of the Home Inventory System (HIS) in accordance with the present invention. When a user (i.e., a customer) purchases a product(s) at a store that has implemented a system which is capable of operatively communicating with the HIS, the user will receive a receipt 210 having a unique identifier (step 302). The unique identifier will be stored by the store database 204 along with data identifying what products were purchased during the transaction indicated by the identifier. The unique identifier will be represented by a bar code on a receipt 210 of the transaction in a preferred embodiment.

The user takes the purchased products home so that the purchased products become a part of the home's inventory and reads the bar code from the receipt 210 with the bar code scanner 106 that is operatively connected to the home computer 102 of the HIS (step 304). Alternatively, a keyboard of the home computer 102 may be used to manually enter the barcode number, particularly if the barcode scanner 106 is not available or functioning properly. If desired, the keyboard can also be used to manually enter information relating to the purchased products. The home computer 102 then contacts (i.e., transmits a contact signal to) the store computer 202 and database 204 through communication ports 108, 208 and a wide area network connection such as an internet or intranet connection (see step 306). In response, the store computer 202 and database 204 download, via the communication ports 108, 208 and the network connection, product information for all of the purchased products in the transaction reflected by the read bar code (i.e., unique identifier) to the home computer 102 and database 104 (step 306). The downloaded product information includes, for example: the amount or number of units purchased, price, expiration date, date/time of purchase, and the store at which the products were purchased.

The downloaded product information is processed by the home computer 102 and stored in the home database 104. The downloaded product information is used by the home computer 102 to update the previously existing (and stored) home inventory information. The updated home inventory information is stored in the home database 104 and can be presented on the display 110 upon the user's request.

Through the bar code provided on the receipt and the purchased product information associated therewith, information regarding inventory coming into the user's home may be downloaded via the network connection to the versatile home database 104. The use of the bar code scanner 106 and the network connection to select and download product information allows home inventory information to be quickly and easily updated and stored in the home computer 102 and database 104.

In addition to the downloaded product information from the store computer 202 and database 204, the home computer 102 and database 104 receives and stores data reflecting (i) a preset condition(s) regarding the usage, expiration and/or disposal of the products in-inventory, (ii) a past usage model(s) customized for a particular user regarding the usage, expiration and/or disposal of the products in-inventory, and (iii) data that is directly entered into the home computer 102 of the HIS by the user regarding the actual usage, expiration and/or disposal of a particular product. The received data reflecting the preset conditions and past usage models may be, for example, transmitted from store computer 202 and database 204. The data reflecting preset conditions includes data reflecting, for example, the rate at which a typical person or group of people (e.g., a family of a particular size) uses a certain product, the rate at which a certain product expires, applications and their required components, and products which may be used as suitable substitutes for other products. The data reflecting past usage models customized for a particular user includes data reflecting, for example, the rate at which the particular user or group of users typically consumes a product, products typically purchased by the particular user, a particular user's favorite applications and their required components (e.g., ingredients of a favorite recipe).

Based upon the home inventory information that has been updated by the downloaded product information stored in the database 104, and the preset conditions, past usage models and/or entered data, the HIS can output automatic reminders to purchase certain products in response to the user's input identifying those products. For example, suppose the user purchased a 12 ounce bottle of shampoo from a store and scanned a bar code from a receipt resulting from that transaction. The store computer 202 and database 204 would download information relating to the shampoo (including the amount) to the home computer 102 which would use the downloaded information to update the home inventory information and store the updated information in the home database 104 (as discussed in steps 302-306 above). The user can provide input into the home computer 102 identifying that he/she would like to receive a reminder at the appropriate time to purchase more shampoo (e.g., step 320). Using a selected past usage model stored in the home database 104 that the user typically finishes a 12 ounce bottle of shampoo in one month, the HIS can output an automatic reminder that the shampoo is running low prior to the end of one month period (e.g., step 330). As a further example, the HIS can output an automatic reminder that the shampoo is running low just prior to the end of a 1½ month period if the previously existing home inventory information revealed that the user already had six ounces of shampoo remaining (from a previous purchase) when the data relating to the 12 ounce bottle was downloaded from the store computer 202 and database 204.

A different past usage model or a preset condition could optionally be selected by the user instead of the one month usage model discussed above to determine when the automatic reminder should be output to notify the user.

Additionally and/or alternatively, the amount of shampoo at any given time may be directly input into the home computer 102 by the user. For example, if a 12 ounce bottle of shampoo was purchased at a time when the user had no shampoo and the one month usage model were selected, the HIS would indicate that the user has six ounces at the time that a half of a month had passed. If, however, the user actually has seven ounces rather than the projected six ounces at that time (i.e., one-half month after the time of purchase), then the user can enter this data directly into the home computer 102. The usage rate can continue to decrement the projected amount of shampoo based upon this directly input information into the home computer 102.

The HIS is also capable of being directed to automatically generate a shopping list listing all of the items in the home inventory that are running low and/or import any of the home inventory information into another computer program such as a budget planning program.

The HIS is also capable of outputting automatic warnings to inform the user when certain products are close to expiration (e.g., unused food products which are close to spoiling) or are totally depleted based upon the home inventory information as updated by the downloaded product information and the preset condition(s), past usage model(s) and/or entered data. For example, suppose the user purchased a carton of milk from a store and scanned a bar code from a receipt resulting from that transaction. Product information relating to the milk would be downloaded and processed by the home computer 102 (as discussed in steps 302-306 above). If the user provided input into the home computer 102 identifying that he/she would like to receive a reminder at the appropriate time to purchase more milk (e.g., step 320) and a preset condition stored in the home database 104 that milk typically spoils in two weeks were selected, the HIS will output an automatic reminder to purchase more milk just prior to the two week period ending (e.g., step 330). A different preset condition or a past usage model can be selected by the user (instead of the two week expiration condition discussed above) to determine when the automatic reminder should be output to notify the user. Additionally, the HIS is capable of generating a shopping list listing all of the items in the home inventory that are about to expire and/or import any of the home inventory information into another computer program. This list, of course, can be combined with the list of home inventory items that are running low or have run out.

The HIS is also capable of receiving and responding to user queries to generate potential solutions based upon the current home inventory information as updated by the downloaded product information and the preset conditions, past usage models and/or directly entered data (steps 322, 332). Specifically, the HIS can provide suggestions on how to use the products prior to expiration in response to the user's query. For example, the HIS can output a menu of favorite recipes (or all possible recipes) based upon available food items in the home's inventory in response to a user's query. A recipe will be deemed possible if all of the ingredients are available and not expired (i.e., unspoiled) as determined by the latest home inventory information. The HIS is also capable of providing suggestions of suitable substitutes that are available as indicated by the inventory stored in the database 104 for expired/depleted item(s) in response to a user's query.

The HIS is also capable of receiving and responding to user queries regarding what items in inventory are missing for a particular application based upon the home inventory information as updated by the downloaded product information and the above discussed preset conditions, past usage models and/or directly entered data (steps 324, 334). For example, if a user entered a query to the computer 102 that he/she wanted to bake a meal that required eggs, flour, sugar and milk, the HIS can provide a list of which of these four ingredients is unavailable or expired from the home's inventory. The HIS is capable of adding the missing ingredient(s) to a shopping list and/or suggesting a suitable substitute for the missing ingredient.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, present invention may, however, be used to track the inventory of business or commercial (i.e., non-home) settings.

What is claimed is:

1. A method comprising:
receiving an identifier in a first computer system, the identifier identifying a transaction in which at least one product has been purchased;
transmitting a contact signal from the first computer system to a second computer system, the second computer system storing information relating to a plurality of available products including the purchased product;
transmitting information relating to the purchased product from the second computer system to the first computer system in response to the second computer receiving the contact signal; and
processing the information relating to the purchased product using the first computer system to update information relating to products in inventory.

2. The method of claim 1 wherein receiving the identifier in the first computer system comprises scanning a bar code representing the identifier, the bar code being printed on a receipt relating to the transaction.

3. The method of claim 1 wherein the contact signal and the information relating to the purchased product are transmitted via an internet connection established between the first and second computer systems.

4. The method of claim 1 further comprising storing data in the first computer system relating to the usage, expiration and/or disposal of the products in inventory.

5. The method of claim 4 wherein the information relating to the products in inventory is updated based upon the stored data relating to the usage, expiration and/or disposal of the products in inventory.

6. The method of claim 4 further comprising receiving an input from a user in the first computer system and generating an output from the first computer system in response to the input from the user based upon the stored data relating to the usage, expiration and/or disposal of the products in inventory.

7. The method of claim 6 wherein the stored data relating to the usage, expiration and/or disposal of the products in inventory includes data reflecting a preset condition.

8. The method of claim 6 wherein the stored data relating to the usage, expiration and/or disposal of the products in inventory includes data reflecting a past usage model that has been customized for a particular user.

9. The method of claim 6 wherein the stored data relating to the usage, expiration and/or disposal of the products in inventory includes data resulting from another input by the user into the first computer that reflects the actual usage, expiration or disposal of the products in inventory.

10. The method of claim 6 wherein generating the output from the first computer system comprises automatically generating a warning to indicate that an amount of at least one of the products in inventory is low or totally depleted.

11. The method of claim 6 wherein generating the output from the first computer system comprises automatically generating a warning to indicate at least one of the products in inventory has or is about to become expired.

12. The method of claim 6 wherein the input from the user represents a query for potential applications using at least one of the products in inventory.

13. The method of claim 6, wherein the input from the user represents a query indicating an application to enable first computer system to determine what product(s) in inventory is unavailable to perform the application.

14. A system comprising:
a first computer system for receiving an identifier identifying a transaction in which at least one product has been purchased, and for storing information relating to products in inventory; and
a second computer system, in operative communication with the first computer system, for storing information relating to a plurality of available products including the purchased product, receiving a contact signal transmitted from the first computer system, and transmitting to the first computer system information relating to the purchased product in response to receiving the contact signal so that the first computer system can process the information relating to the purchased product so that the information relating to the products in inventory can be updated.

15. The system of claim 14 wherein the first computer system comprises a bar code scanner for reading the identifier, the identifier being printed on a receipt relating to the transaction.

16. The system of claim 14 further comprising an internet connection established between the first and second computer systems for transmitting the contact signal system and the information relating to the purchased product.

17. The system of claim 14 wherein the first computer system stores data relating to the usage, expiration and/or disposal of the products in inventory.

18. The system of claim 17 wherein the first computer system updates the stored information relating to the products in inventory based upon the stored data relating to the usage, expiration and/or disposal of the products in inventory.

19. The system of claim 17 wherein the first computer receives an input from a user in the first computer system and generates an output in response to the input from the user based upon the information relating to at least one of the products in inventory and the stored data relating to the usage, expiration and/or disposal of the products in inventory.

20. The system of claim 18 wherein the stored data relating to the usage, expiration and/or disposal of the products in inventory includes data reflecting a preset condition.

21. The system of claim 18 wherein the stored data relating to the usage, expiration and/or disposal of the products in inventory includes data reflecting a past usage model that has been customized for a particular user.

22. The system of claim 18 wherein the stored data relating to the usage, expiration and/or disposal of the products in inventory includes data resulting from another input by the user into the first computer that reflects the actual usage, expiration or disposal of at least one of the products in inventory.

23. The system of claim 19 wherein the first computer system automatically generates a warning to indicate that an amount of at least one of the products in inventory is low or totally depleted.

24. The system of claim 19 wherein the first computer system automatically generates a warning to indicate that at least one of the products in inventory has or is about to become expired.

25. The system of claim 19 wherein the first computer system receives input from the user representing a query for potential applications using at least one of the products in inventory.

26. The system of claim 19 wherein the first computer system receives input from the user representing a query indicating an application, and determines what product(s) is unavailable to perform the application.

27. A system for tracking inventory comprising:
a receiver for receiving an identifier that identifies a transaction in which at least one product has been purchased;
a computer operatively coupled to the receiver for generating a contact signal after receiving the identifier from the receiver; and
a communication port operatively coupled to the computer for receiving the contact signal from the computer and transmitting the contact signal externally from the system, and for receiving information relating to the purchased product in response to transmitting the contact signal;
wherein the computer processes the received information relating to the purchased product to update information relating to products in inventory.

28. The system of claim 27 wherein the receiver comprises a bar code scanner for reading the identifier from a receipt relating to the transaction.

29. The system of claim 27 wherein the communication port establishes an internet connection to transmit the contact signal and receive the information relating to the purchased product.

30. The system of claim 27 further comprising a database for storing data relating to the usage, expiration and/or disposal of the products in inventory.

31. The system of claim 30 wherein the computer receives an input from a user and generates an output in response to the input from the user based on the stored data relating to the usage, expiration and/or disposal of the products in inventory.

32. The system of claim 31 wherein the stored data relating to the usage, expiration and/or disposal of the products in inventory includes data reflecting a preset condition.

33. The system of claim 31 wherein the stored data relating to the usage, expiration and/or disposal of the products in inventory includes data reflecting a past usage model that has been customized for a particular user.

34. The system of claim 31 wherein the stored data relating to the usage, expiration and/or disposal of the products in inventory includes data resulting from another input by the user into the first computer that reflects the actual usage, expiration or disposal of at least one of the products in inventory.

35. The system of claim 31 wherein the computer automatically generates a warning to indicate that an amount of at least one of the products in inventory is low or totally depleted.

36. The system of claim 31 wherein the computer automatically generates a warning to indicate that at least one of the products in inventory has or is about to become expired.

37. The system of claim 31 wherein the computer receives input from the user representing a query for potential applications using at least one of the products in inventory.

38. The system of claim 31 wherein the first computer system receives input from the user representing a query indicating an application, and determines what product(s) in inventory is unavailable to perform the application.

39. A method of tracking inventory comprising:
storing information relating to products in inventory and data relating to the usage, expiration and/or disposal of the products in inventory in a computer system;
receiving an input from the user in the computer system, the input representing a query that indicates an application; and
determining what product(s) in inventory is unavailable to perform the application based on the stored information relating to the products in inventory and data relating to the usage, expiration and/or disposal of the products in inventory.

40. The method of claim 39 wherein the stored data relating to the usage, expiration and/or disposal of the products in inventory includes data reflecting a preset condition.

41. The method of claim 39 wherein the stored data relating to the usage, expiration and/or disposal of the products in inventory includes data reflecting a past usage model that has been customized for a particular user.

42. The method of claim 39 wherein the stored data relating to the usage, expiration and/or disposal of the products in inventory includes data resulting from another input by the user into the computer system that reflects the actual usage, expiration or disposal of at least one of the products in inventory.

43. A method of tracking inventory comprising:
storing information relating to the products in inventory and data relating to the usage, expiration and/or disposal of the products in inventory in a computer system;
receiving an input from the user in the computer system, the input representing a query for potential applications; and
determining potential applications that are capable of being performed based on the stored information relating to the products in inventory and data relating to the usage, expiration and/or disposal of the products in inventory.

44. The method of claim 43 wherein the stored data relating to the usage, expiration and/or disposal of the products in inventory includes data reflecting a preset condition.

45. The method of claim 43 wherein the stored data relating to the usage, expiration and/or disposal of the products in inventory includes data reflecting a past usage model that has been customized for a particular user.

46. The method of claim 39 wherein the stored data relating to the usage, expiration and/or disposal of the products in inventory includes data resulting from another input by the user into the computer system that reflects the actual usage, expiration or disposal of at least one of the products in inventory.
